(19) United States
(12) Patent Application Publication
(10) Pub. No.: US 2024/0273002 A1
(43) Pub. Date: Aug. 15, 2024

(54) METHOD FOR PROVIDING INFORMATION ABOUT A SECURITY-CRITICAL SOFTWARE STATE OF AN EMBEDDED DEVICE

(71) Applicant: Robert Bosch GmbH, Stuttgart (DE)

(72) Inventor: Paulius Duplys, Markgroeningen (DE)

(21) Appl. No.: 18/539,536

(22) Filed: Dec. 14, 2023

(30) Foreign Application Priority Data
Feb. 9, 2023 (DE) 10 2023 201 038.0

(51) Int. Cl. G06F 11/34; G06F 21/56

(52) U.S. Cl. CPC G06F 11/3466; G06F 21/566

(57) ABSTRACT

A method for providing information about a security-critical software state of an embedded device, wherein the embedded device has a network connection to a central monitoring unit for the central monitoring of the embedded device and of further embedded devices. The method includes: ascertaining execution traces of at least one software executed on the embedded device; determining an identifier for the executed software on the basis of the ascertained execution traces, wherein the identifier is specific to an identity and/or to enabled functions of the executed software; determining the information about the security-critical software state on the basis of the identifier; providing the information about the security-critical software state for the central monitoring unit via the network connection.

### CROSS REFERENCE

The present application claims the benefit under 35 U.S.C. § 119 of German Patent Application No. DE 10 2023 201 038.0 filed on Feb. 9, 2023, which is expressly incorporated herein by reference in its entirety.

### FIELD

The present invention relates to a method for providing information about a security-critical software state of an embedded device. The present invention also relates to a computer program, an apparatus and a system for this purpose.

### BACKGROUND INFORMATION

Software parts lists, such as a software bill of materials, SBOM for short, which lists the software components used in an embedded device, are conventionally available. Such a parts list is often created by the software developer in the development phase and can be updated during the operational phase. The update takes place, for example, when the embedded device receives an update or additional software packages.

The problem with a conventional SBOM-based approach can be that SBOMs are too coarse to provide useful information for complex software packages. This is problematic in particular from a security perspective. For example, for such packages, a request to a database such as NVD provides a long list of known vulnerabilities. However, most of these vulnerabilities can only be exploited if particular functions of the software package are enabled. For example, the NVD database lists about 6000 known security gaps for the Linux kernel 4.14. However, each of these flaws is only relevant to a particular product if the corresponding kernel feature is actually being used and if the flaw can actually be exploited in practice, given the specifications of the product and its software configuration. Consequently, a conventional SBOM can often be insufficient to check whether a particular vulnerability for a particular product is in fact relevant.

Furthermore, the conventional use of SBOMs can be error-prone since the SBOM is created in the development environment during the product development phase. However, the actual software can be executed on a remote embedded device. This type of setup results in a natural source of discrepancies between the ideal world, described in the SBOM, and the real world determined by the actual software running on a particular embedded device. In particular in the case of uses with a large number, for example hundreds of thousands, of devices, or with embedded devices capable of initiating software updates, it is very difficult to ensure that the information in a SBOM accurately reflects the software running on a particular embedded device.

One difficulty with a traditional host-based intrusion detection system approach is that an additional system must be installed on the embedded device.

### SUMMARY

The present invention includes a method for providing information about a security-critical software state of an embedded device, a computer program, and a system. Features and details of the present invention emerge from the disclosure herein. Of course, features and details described in connection with the method according to the present invention also apply in connection with the computer program according to the present invention, the apparatus according to the present invention, and the system according to the present invention, and respectively vice versa, so that, with respect to the disclosure, mutual reference to the individual aspects of the present invention is or can always be made.

An object of the present invention is in particular a method for providing information about a security-critical software state of an embedded device and preferably for detecting the security-critical software state and/or monitoring the software state of the embedded device. In this case, in particular for providing the information, the embedded device can have a network connection to a central monitoring unit for the central monitoring of the embedded device and preferably further embedded devices. For this purpose, the embedded device can comprise a network interface, which is, for example, connected to the Internet and/or a mobile network, and/or the like.

The method according to an example embodiment of the present invention can comprise the following steps, which are preferably performed sequentially and/or repeatedly, particularly preferably by an agent component, which is, for example, designed as a software or hardware component of the embedded device:
ascertaining execution traces of at least one software executed on the embedded device, preferably by tracing in the software and/or by reading out an access log of accesses by the software and/or the like,
determining an identifier, preferably in the form of a digital fingerprint, for the executed software on the basis of the ascertained execution traces, wherein the identifier is specific to an identity and/or to enabled functions of the executed software,
determining the information about the security-critical software state, and preferably about the identity and/or the enabled functions, on the basis of the identifier,
providing the information about the security-critical software state for the central monitoring unit via the network connection.

The present invention can advantageously make it possible to identify software that runs on a large number of embedded devices, viz., in a manner that is robust to the discrepancies occurring in conventional solutions, and that can also be used to detect inadvertent or malicious changes to the software running on an embedded device, and to detect malware. The identifier can, for example, be designed as a digital fingerprint, also referred to as a software fingerprint. The software state can, for example, indicate the identity of the executed software and/or its enabled functions.

Furthermore, the present invention can provide a solution to automatically determine which software runs with which enabled properties on an embedded device. In particular, this can avoid manual (software developer) or tool-aided a priori creation of a SBOM since this approach can lead to inconsistencies between the “SBOM view” and the software actually running on an embedded device.

According to an example embodiment of the present invention, it can be provided that unique patterns in the execution traces of the software are ascertained in order to determine the identifier. When a software is executed, its execution trace contains, for example, information about the memory addresses accessed by the software. Moreover, software can access, create, or modify operating system resources. This can, for example, include the access and/or creation and/or modification of a file, network socket, and/or system call, and/or the like. Consequently, the information about this access in the software execution traces can be considered as a unique software fingerprint. By adding an agent that reads and evaluates software execution traces, for example regularly or due to a particular trigger, to the embedded device, the software actually running on an embedded device can be ascertained. This information can then be transmitted, for example, to a backend, e.g., a security operations center, or SOC for short, of the manufacturer or operator so that a true digital twin of the embedded device can be created and maintained rather than creating a SBOM in the development phase.

According to an example embodiment of the present invention, it is possible that the respective embedded device and the software executed thereon is used to control a vehicle. Accordingly, it is possible that the method according to the present invention is used in one or more vehicles. The respective vehicle can, for example, be designed as a motor vehicle and/or a passenger vehicle and/or an autonomous vehicle. The respective vehicle can comprise the embedded device as part of a vehicle device, for example for providing an autonomous driving function and/or a driver assistance system. The vehicle device can be designed to at least partially automatically control and/or accelerate and/or brake and/or steer the vehicle.

According to an example embodiment of the present invention, it is furthermore possible that determining the information about the security-critical software state comprises the following steps, which are preferably performed by the embedded device, preferably by an agent component:
comparing the identifier with at least one specification for determining the identity and/or the enabled functions of the executed software, wherein a match of the identifier with at least one of several entries in a database is preferably ascertained for this purpose,
detecting the security-critical software state on the basis of the comparison, in particular in the event of a deviation of the identifier from the at least one specification, preferably from each of the entries,
defining the information about the security-critical software state on the basis of the comparison and/or the detection.

This makes it possible to use the specification and in particular the database to check that only permitted software, in particular software components, are executed. For this purpose, the database can be designed as a fingerprint database, which comprises a collection of specified identifiers. This collection thus represents the target software state. If the identifier is not found in the collection, this is an indication of a third-party software and can represent a security-critical state. In the event that the security-critical software state is detected, a security measure can therefore be initiated, particularly preferably by a response module of the embedded device, wherein the security measure comprises at least one of the following actions:
restarting the embedded device,
updating the executed software,
degrading the embedded device,
alerting the central monitoring unit.

It is furthermore possible in the context of an example embodiment of the present invention that providing the information about the security-critical software state comprises the following step:
transmitting the information to the central monitoring unit in order to update a digital twin of the embedded device.

In this case, the central monitoring unit can be designed as a backend that is connected with several further embedded devices and provides their digital twins.

Optionally, according to an example embodiment of the present invention, it can be provided that the information about the security-critical software state provided for the central monitoring unit comprises at least one of the following items of information:
the identifier,
information about the identity and/or the enabled functions of the executed software,
a result of comparing the identifier with at least one specification,
a result of detecting the security-critical software state on the basis of the comparison.

According to an example embodiment of the present invention, it is furthermore possible that the detection of the security-critical state is carried out by the embedded device itself or only by the central monitoring unit on the basis of the information provided.

Furthermore, according to an example embodiment of the present invention, it can be provided that ascertaining the execution traces comprises at least one of the following steps:
ascertaining an access of the executed software to memory addresses of the embedded device,
ascertaining a file access of the executed software on the embedded device,
ascertaining an access to operating system resources of the executed software on the embedded device,
ascertaining an imprint at the hardware or operating system level of the embedded device, which imprint results from an instrumented software package.

This makes it possible to ascertain different types of identifiers, in particular digital fingerprints. Alternatively, or additionally, according to an example embodiment of the present invention, it can be provided that the identifier is specific to imprints from a predefined number of sequential execution steps of the software in order to determine the identifier as a stateful fingerprint. For example, a sequence of executions of the software results in a particular pattern of traces, which can form the identifier.

An object of the present invention is also a system comprising several connected embedded devices, which are respectively configured to perform the method according to the present invention in order to provide the information about the security-critical software state of the respective embedded device for the central monitoring unit. Thus, the system according to the present invention offers the same advantages as have been described in detail with reference to a method according to the present invention.

The present invention also relates to a computer program, in particular a computer program product, comprising instructions that, when the computer program is executed by a computer, cause the computer to perform the method according to the present invention. Thus, the computer program according to the present invention offers the same advantages as have been described in detail with reference to a method according to the present invention.

An object of the present invention is also an apparatus for data processing, which is configured to perform the method according to the present invention. The embedded device that executes the computer program according to the present invention can, for example, be provided as the apparatus. According to an example embodiment of the present invention, the embedded system can comprise at least one processor for executing the computer program. A non-volatile data memory can also be provided, in which the computer program can be stored and from which the computer program can be read by the processor for execution. The embedded device can also be referred to as an embedded computer or embedded system. It may be a computer that is adapted for a particular task and is fixedly integrated into a machine, such as a vehicle, and/or a device, such as a tool, in order to provide a specific function.

An object of the present invention can also be a computer-readable storage medium comprising the computer program according to the present invention. The storage medium is, for example, designed as a data store, such as a hard drive and/or a non-volatile memory and/or a memory card. The storage medium can, for example, be integrated into the embedded device.

Moreover, the method according to the present invention can also be designed as a computer-implemented method.

Further advantages, features and details of the present invention arise from the following description, in which exemplary embodiments of the present invention are described in detail with reference to the figures. In this context, the features mentioned in the description can each be essential to the present invention, individually or in any combination.

### BRIEF DESCRIPTION OF THE DRAWINGS

FIG. 1 shows a schematic visualization of a method, an apparatus and a computer program according to exemplary embodiments of the present invention.

FIG. 2 shows a schematic representation of an architecture of design variants of the present invention.

### DETAILED DESCRIPTION OF EXAMPLE EMBODIMENTS

In the following figures, identical reference signs are used for the same technical features even of different exemplary embodiments.

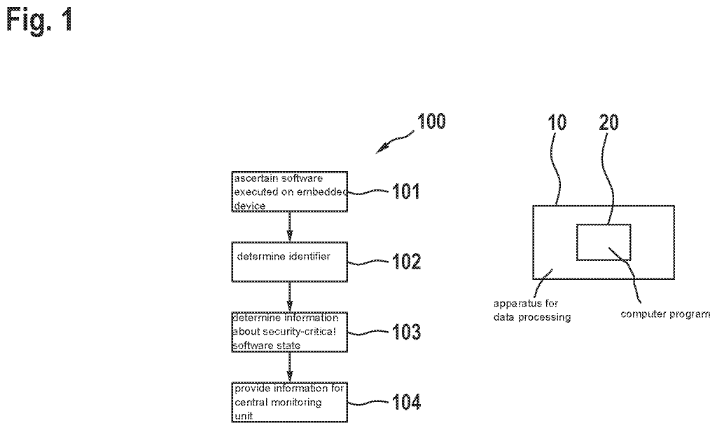

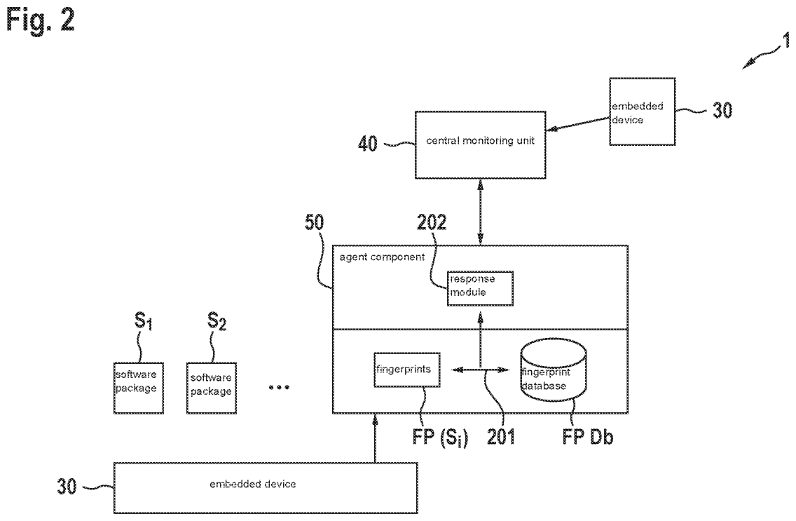

Design variants of the present invention are shown schematically in FIGS. 1 and 2. The design variants can be used in connection with embedded devices 30, which are used in large numbers. FIG. 1 also shows a computer program 20, an apparatus 10 for data processing, and a system 1 with several connected embedded devices 30.

FIG. 1 illustrates, according to exemplary embodiments of the present invention, a method 100 for providing information about a security-critical software state of an embedded device 30. For this purpose, the embedded device 30 can have a network connection to a central monitoring unit 40.

At least one software executed on the embedded device 30 can be ascertained according to a first method step 101. According to a second method step 102, at least one identifier for the executed software can be determined on the basis of the ascertained execution traces, wherein the (respective) identifier is specific to an identity and/or to enabled functions of the executed software. Then, according to a third method step 103, the information about the security-critical software state can be determined on the basis of the identifier. It is possible for the third method step 103 to be performed by the embedded device 30, preferably by an agent component 50. According to a fourth method step 104, the information about the security-critical software state can be provided for the central monitoring unit 40 via the network connection.

In the event that the security-critical software state is detected, a security measure can be initiated, particularly preferably by a response module 202, illustrated in FIG. 2, of the embedded device 30.

It can furthermore be provided that the embedded devices 30 are connected, i.e., in particular, have a network connection so that the embedded devices 30 can be centrally monitored via a data network, such as the Internet and/or a mobile network, in particular in order to detect the security-critical software state. The central monitoring unit 40 can be provided for the central monitoring.

In order to ensure security in connected embedded devices, it is often necessary to know what software is running on each embedded device 30 and what functions of this software are actually enabled. In particular in fleets of connected embedded devices managed by a manufacturer or operator (e.g., telemetry units built into a particular vehicle model), this can be an important prerequisite for secure operation.

Information about a software state, in particular a security-critical software state, is hereinafter in particular understood to be information about what software is being executed on an embedded device 30 and, preferably, which functions of this software are actually enabled. This information can be required for several purposes.

One purpose for using the information can be to identify specific software packages installed on an embedded device 30. In this context, it can also be identified which functions of these packages are enabled. This makes it possible, for example, for an over-the-air update to be carried out. Such an update is necessary, for example, when security gaps are reported to databases such as the NVD (National Vulnerability Database). For example, a software parts list (software bill of materials, SBOM) listing the software components used in the relevant product is maintained for this purpose. The parts list is preferably created by the software developer in the development phase and can be updated during the operational phase. The update takes place, for example, when an embedded device 30, which is used in the field, receives an update or additional software packages.

A further purpose for using the information can be to ensure that no software, such as malicious software, unknown to the manufacturer or operator is running on the embedded device 30. This can be achieved by an additional mechanism, such as a host-based intrusion detection system (HIDS) added to the embedded device 30. In the embedded field, the HIDS can be configured to report abnormalities that deviate from the expected behavior at the operating system level. For example, processes, system calls, handles, attempts to open a port or to start an outgoing connection can be detected by the HIDS and optionally reported to a security operations center 40 (SOC) of the manufacturer or the operator (see FIG. 2). The SOC 40 can also be referred to more generally as a central monitoring unit 40.

According to exemplary embodiments of the present invention, a unique pattern in software execution traces can be ascertained. The execution traces can comprise information about the memory addresses accessed by a software. The execution traces can also comprise information about access of the software to operating system resources. Consequently, the information in the software execution traces can be considered as a unique software fingerprint.

For ascertaining and using the execution traces, an agent 50 can be provided on the embedded device 30. This agent 50 is, for example, a software component and/or hardware component that reads and evaluates software execution traces regularly or due to a particular trigger. In this way, the software actually running on an embedded device 30 can be ascertained. This information can then be transmitted to the backend 40, e.g., an SOC 40 of the manufacturer or operator, so that a true digital twin of the embedded product can be created and maintained rather than creating a SBOM in the development phase. For example, execution traces are ascertained by a tracing.

It is possible that the embedded device 30 can have (further) update functions or intrusion protection functions. Thus, it can also respond autonomously to the information contained in the software-execution-based fingerprints. For example, if a distorted known fingerprint is detected, possibly as a result of malware located on embedded device 30, the device 30 can in this way carry out a restart and thus remove the malware from its main memory.

An architecture of design variants of the present invention is shown in FIG. 2. In this case, the agent 50 runs as a software component on an embedded device 30 and collects the fingerprints FP (S₁) of the software packages S₁, S₂, . . . executed on this embedded device 30. Subsequently, a comparison 201 of these fingerprints with a fingerprint database “FP Db” can be carried out. Depending on the result of the comparison and optionally on a policy specified by the agent 50, a previously defined response 202 can then be triggered. For example, the agent 50 can alert the backend 40, bring about an update to a particular software package, degrade the functionality of the device 30 (graceful degradation), or restart the embedded device 30. Moreover, the agent 50 is connected to a backend 40, e.g., an SOC 40 and can transmit the information about the detected, missing, or distorted fingerprints to the backend 40. The backend 40 can in turn update the digital twin of the embedded device 30. There can be several design variants of the present invention that can be implemented depending on the capabilities of the embedded device 30 and the desired level of accuracy or security.

The database shown in FIG. 2, in particular fingerprint database, “FP Db,” can, for example, be created in the product development phase by profiling the software packages to be installed on the embedded device 30 as well as their functions to be enabled on the embedded device 30. There are several possibility of how the database can be updated during the life cycle of the embedded device 30. One possibility is to profile new versions of the software packages or new software packages in the backend 40 and to transmit this information to the embedded device 30. A further possibility is for the agent 50 to collect this information on the embedded device 30, to transmit it to the backend 40, and to check in the backend 40 whether these new fingerprints originate from the expected, uncompromised software packages or from expected software functions. Depending on the result of this check, the agent 50 can be instructed to permanently add the new fingerprint to the “FP Db” or to trigger a response.

A response module 202 (react) can furthermore be provided (see FIG. 2). The capabilities of the react module can vary depending on the desired level of autonomy and protection. The module itself can be implemented in either software or hardware. In the simplest case, react 202 only transmits data to the backend 40, for example if an observed fingerprint does not match the expected fingerprint stored in the “FP Db.” In an advanced setup, the react module can be provided with functions to stop processes, to close network ports, to restrict access to particular system resources, or even to restart the embedded device 30.

There can be various types of fingerprints that the agent 50 can trace. For embedded devices without or with a very simple operating system (or if a high level of security is desired), the agent 50 can be designed to detect fingerprints at the hardware level of software execution traces. These imprints consist of the information about the memory addresses that a particular software package accesses. From the security perspective, hardware-level logs are more precise since they also make it possible to detect control-flow hijacking, i.e., a situation in which a legitimate program is executed but its control flow is hijacked by malicious payload data.

An alternative to hardware-level fingerprints are OS-level fingerprints, which describe the (expected) software execution trace at the abstraction level of an operating system. For example, if the software S1 reads a particular file or writes temporary data to a particular folder of the operating system or makes a particular system call, these events are part of the program flow chart at the operating system level. Fingerprints at the operating system level are simpler to use or require less access to the underlying hardware and are therefore technically simpler to implement on more powerful embedded devices than fingerprints at the hardware level.

The agent 50 itself can be implemented in software and run as a (privileged) process on the embedded device 30. A software agent 50 is expedient especially when using fingerprints at the operating system level. Alternatively, the agent 50 can also be implemented in hardware or use specific hardware support in the CPU of the embedded device 30. For example, particular CPU models have enhanced tracing functions that can be used to record software execution traces.

One alternative is the use of implicit software execution traces. When executed, each software generates unique patterns in its software execution trace. This inherent information can be used as a fingerprint of the corresponding software.

One possibility is to use active fingerprints. This involves instrumenting the software packages, either at the source code level or directly in the binary files, by inserting non-functional code snippets that create a unique imprint at the hardware or operating system level. In the case of source code, this can be achieved by means of compiler pragmas that prevent the code from being optimized. For binary files, this can be achieved using the same techniques used to instrument binary files for fuzzing. Active fingerprints have the advantage that they are particularly easy to trace and thus ensure reliable detection. For example, an active fingerprint that writes a file having a particular name and/or content can be inserted. As this is very easy to detect, the agent 50 can be implemented in a simple manner.

A further possibility are stateless fingerprints such as the example described above on the basis of files. Also possible is the use of state-dependent fingerprints in which the fingerprint consists of several consecutive valid states. For example, a hardware-level fingerprint could consist of several specific values v1, v2, . . . , vk expected at a particular storage location when the program is run k times, for example in the case of round-robin-based scheduling. Another example would be a fingerprint at the operating system level, in which case it is expected that a particular directory contains files named f1, f2, . . . fk when the software is called k times.

Exemplary embodiments of the present invention can dynamically provide fingerprints of software running on embedded devices, and this information can be passed on to the backend 40, and active or stateful fingerprints can in particular be used.

In this case, the advantage can be achieved that tracing the specific software running on the embedded devices is much less error-prone for outdated information. A SBOM is essentially just a document that is created and saved in the backend 40. Since there is no mechanism to ensure that the SBOM and the software running on the embedded device 30 are synchronous, discrepancies can easily occur. The approach proposed according to design variants of the present invention goes the opposite route. The agent 50 observes the software executed on the embedded device 30 and transmits this information to the backend 40. The digital twin of an embedded device 30 thus always has up-to-date information about the software executed on the device 30. Secondly, the proposed system makes it possible to build reliable distributed systems and even to adapt them to embedded devices 30 from third-party vendors or in scenarios where the software to be executed on the embedded device 30 is not known to the manufacturer or operator of the device 30 in advance. This also means that open systems can be built in which there are devices 30 that are not controlled by the manufacturer or operator.

The above description of the exemplary embodiments describes the present invention solely in the context of examples. Of course, individual features of the embodiments can be freely combined with one another, if technically expedient, without leaving the scope of the present invention.

What is claimed is:

1. A method for providing information about a security-critical software state of an embedded device, wherein, for the providing of the information, the embedded device has a network connection to a central monitoring unit for the central monitoring of the embedded device and of further embedded devices, the method comprising the following steps:
ascertaining execution traces of at least one software executed on the embedded device;
determining an identifier for the executed software on based on the ascertained execution traces, wherein the identifier is specific to an identity and/or to enabled functions of the executed software;
determining the information about the security-critical software state based on the identifier; and
providing the information about the security-critical software state for the central monitoring unit via the network connection.

2. The method according to claim 1, wherein the determining of the information about the security-critical software state includes the following steps:
comparing the identifier with at least one specification for determining an identity and/or enabled functions of the executed software, wherein a match of the identifier with at least one of several entries in a database is ascertained;
detecting the security-critical software state based on the comparison, wherein, in the event of a deviation of the identifier from the at least one specification, from each of the entries;
defining the information about the security-critical software state based on the comparison and/or the detection, wherein, in the event that the security-critical software state is detected, a security measure is initiated by a response module of the embedded device, wherein the security measure includes at least one of the following actions:
restarting the embedded device,
updating the executed software,
degrading the embedded device,
alerting the central monitoring unit.

3. The method according to claim 1, wherein the determining of the information about the security-critical software state is performed by the embedded device by an agent component.

4. The method according to claim 1, wherein the providing of the information about the security-critical software state includes the following step:
transmitting the information to the central monitoring unit to update a digital twin of the embedded device, wherein the central monitoring unit is configured as a backend that is connected to several further embedded devices and provides digital twins of the several further embedded devices.

5. The method according to claim 1, wherein the information about the security-critical software state provided for the central monitoring unit includes at least one of the following items of information:
the identifier,
information about an identity and/or enabled functions of the executed software,
a result of comparing the identifier with at least one specification,
a result of detecting the security-critical software state based on the comparison.

6. The method according to claim 1, wherein the ascertaining of the execution traces includes at least one of the following steps:
ascertaining an access of the executed software to memory addresses of the embedded device,
ascertaining a file access of the executed software on the embedded device,
ascertaining an access to operating system resources of the executed software on the embedded device.

7. The method according to claim 1, wherein the ascertaining of the execution traces includes the following step:
ascertaining an imprint at the hardware or operating system level of the embedded device, the imprint resulting from an instrumented software package.

8. The method according to claim 1, wherein the identifier is specific to imprints from a predefined number of sequential execution steps of the software in order to determine the identifier as a stateful fingerprint.

9. A non-transitory computer-readable medium on which is stored a computer program including instructions for providing information about a security-critical software state of an embedded device, wherein, for the providing of the information, the embedded device has a network connection to a central monitoring unit for the central monitoring of the embedded device and of further embedded devices, the instructions, when executed by a computer, causing the computer to perform the following steps:
ascertaining execution traces of at least one software executed on the embedded device;
determining an identifier for the executed software on based on the ascertained execution traces, wherein the identifier is specific to an identity and/or to enabled functions of the executed software;
determining the information about the security-critical software state based on the identifier; and
providing the information about the security-critical software state for the central monitoring unit via the network connection.

10. An apparatus for data processing, configured to provide information about a security-critical software state of an embedded device, wherein, for the providing of the information, the embedded device has a network connection to a central monitoring unit for the central monitoring of the embedded device and of further embedded devices, the apparatus configured to:
ascertain execution traces of at least one software executed on the embedded device;
determine an identifier for the executed software on based on the ascertained execution traces, wherein the identifier is specific to an identity and/or to enabled functions of the executed software;
determine the information about the security-critical software state based on the identifier; and
provide the information about the security-critical software state for the central monitoring unit via the network connection.

11. A system, comprising:
several connected embedded devices, each embedded device configured to provide information about a security-critical software state of the embedded device, wherein, for the providing of the information, the embedded device having a network connection to a central monitoring unit for the central monitoring of the several embedded devices, each of the embedded devices being configured to:
ascertain execution traces of at least one software executed on the embedded device;
determine an identifier for the executed software on based on the ascertained execution traces, wherein the identifier is specific to an identity and/or to enabled functions of the executed software;
determine the information about the security-critical software state based on the identifier; and
provide the information about the security-critical software state for the central monitoring unit via the network connection.
